(19) United States
(12) Patent Application Publication
(10) Pub. No.: US 2012/0189400 A1
(43) Pub. Date: Jul. 26, 2012

(54) FLOATING FASTENER

(76) Inventor: Ming-Chung CHIU, Sijhih City (TW)

(21) Appl. No.: 13/010,358

(22) Filed: Jan. 20, 2011

(51) Int. Cl. F16B 39/02

(52) U.S. Cl. 411/82

(57) ABSTRACT

A floating fastener includes a mounting socket, which has a center hole on a flexible transverse wall at one end thereof and mounting ring with a bonding surface for bonding to a plate member, a locking member, which has a fastening end piece forced through the center hole of the mounting socket and stoppable at one side of the flexible transverse wall, a head, a plain stem extending through the center hole and connected between the head and the fastening end piece and a shoulder connected between the head and the plain stem and engageable with a relatively thicker center area of the transverse wall around the center hole, and a spring member sleeved onto the locking member and stopped between the head of the locking member and the mounting ring of the mounting socket.

### BACKGROUND OF THE INVENTION

1. Field of the Invention

The present invention relates to fasteners for joining metal plate members and more particularly, to a floating fastener consisting of a mounting socket, a locking member and a spring member, which facilitates installation.

2. Description of the Related Art

When fastening plate members together, positioning screws that are each formed of a knob, a ring and a screw nail are usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing. However, during a mounting or dismounting operation, the screw nails may be lost accidentally, causing installation problems.

To facilitate detachable installation and to avoid missing component parts, floating captive screws are created. FIG. 14 illustrates a floating captive screw according to the prior art. According to this design, the floating captive screw comprises a mounting socket A, a lock screw B floating in the mounting socket A, a spring member A1 sleeved onto the lock screw B and stopped between a mounting flange A2 around the periphery of the mounting socket A and a head B1 of the lock screw B, a stop member A3 mounted inside the mounting socket A, and a screw nut C threaded onto a threaded shank B2 of the lock screw B after insertion of the threaded shank B2 of the lock screw B through the stop member A3 and a inside chamber A0 of the mounting socket A. Further, the mounting socket A has a bottom bonding end A4 for bonding to a plate member D.

This design of floating captive screw is still not satisfactory in function, and has drawbacks as follows:

1. Because floating captive screw consists of the mounting socket A, the spring member A1, the stop member A3, the lock screw B and the screw nut C, it is expensive to manufacture and complicates to install, wasting much labor and time in installation.

2. The bottom bonding end A4 of the mounting socket A is not deeply inserted into the mounting though hole on the plate member D for bonding. When fastening or unfastening the lock screw B, the mounting socket A may be vibrated and forced away from the plate member D accidentally.

Therefore, it is desirable to provide a floating fastener that eliminates the drawbacks of the aforesaid prior art design that consists of a great number of component parts, tends to be disconnected from the connected plate member, and requires much time and labor during installation.

### SUMMARY OF THE INVENTION

The present invention has been accomplished under the circumstances in view. It is therefore an object of the present invention to provide a floating fastener, which is easy and inexpensive to manufacture and easy to install, saving much installation labor and time.

To achieve this and other objects of the present invention, a floating fastener is adapted for mounting in a first plate member for detachably fastening the first plate member to a second plate member, comprising a mounting socket, a locking member and a spring member. The mounting socket comprises an open chamber, a transverse wall, a center hole cut through the transverse wall and disposed in communication with the open chamber, a mounting ring, a bonding surface for bonding to the first plate member and a plurality of locating portions located on the bonding surface. Further, the transverse wall has a relatively thicker center area that is elastically deformable and extends around the center hole. The locking member is adapted for fastening to the second plate member after bonding of the bonding surface of the mounting socket to the first plate member, comprising a head suspending outside the mounting socket, a fastening end piece fastenable to the second plate member, a plain stem connected between the head and the fastening end piece and inserted through the center hole of the mounting socket, a shoulder connected between the head, and a plurality of engagement portions located on the shoulder and engageable with the relatively thicker center area of the transverse wall. The spring member is sleeved onto the fastening end piece, plain stem and shoulder of the locking member and stopped between the head of the locking member and a part of the mounting socket. As the floating fastener simply consists of the mounting socket, the locking member and the spring member, it is easy and inexpensive to manufacture and easy to install, saving much installation labor and time.

Subject to the design of the locating portions on the bonding surface, solder paste accommodation gaps are formed in between the bonding surface and the first plate member for accommodating a solder material when the bonding surface is attached to the first plate member for bonding.

In one embodiment of the present invention, the open chamber extends axially through two distal ends of the mounting socket, the transverse wall of the mounting socket is located on one end of the mounting socket, and the mounting ring extends around the periphery of the mounting socket and defines a bearing wall on the top side thereof and a bottom wall on the bottom side thereof that forms the bonding surface.

In an alternate form of the present invention, the transverse wall of the mounting socket is disposed inside the open chamber;

the mounting ring extends axially from one end of the mounting socket and has an outer diameter smaller than the mounting socket, and the bonding surface is located on one end of the mounting socket and extending around the mounting ring.

Further, the locating portions can be locating grooves, or raised portions protruded from the bonding surface. Further, the fastening end piece of the locking member can be a threaded shank, or a lock pin.

Further, the engagement portions can be located on the periphery of the shoulder. Alternatively, the engagement portions can be located on the beveled bottom edge of the shoulder and equiangularly spaced around the plain stem of the locking member.

### BRIEF DESCRIPTION OF THE DRAWINGS

FIG. 1 is an elevational view of a floating fastener in accordance with a first embodiment of the present invention.

FIG. 2 is an exploded view of the floating fastener in accordance with the first embodiment of the present invention.

FIG. 3 corresponds to FIG. 2 when viewed from another angle.

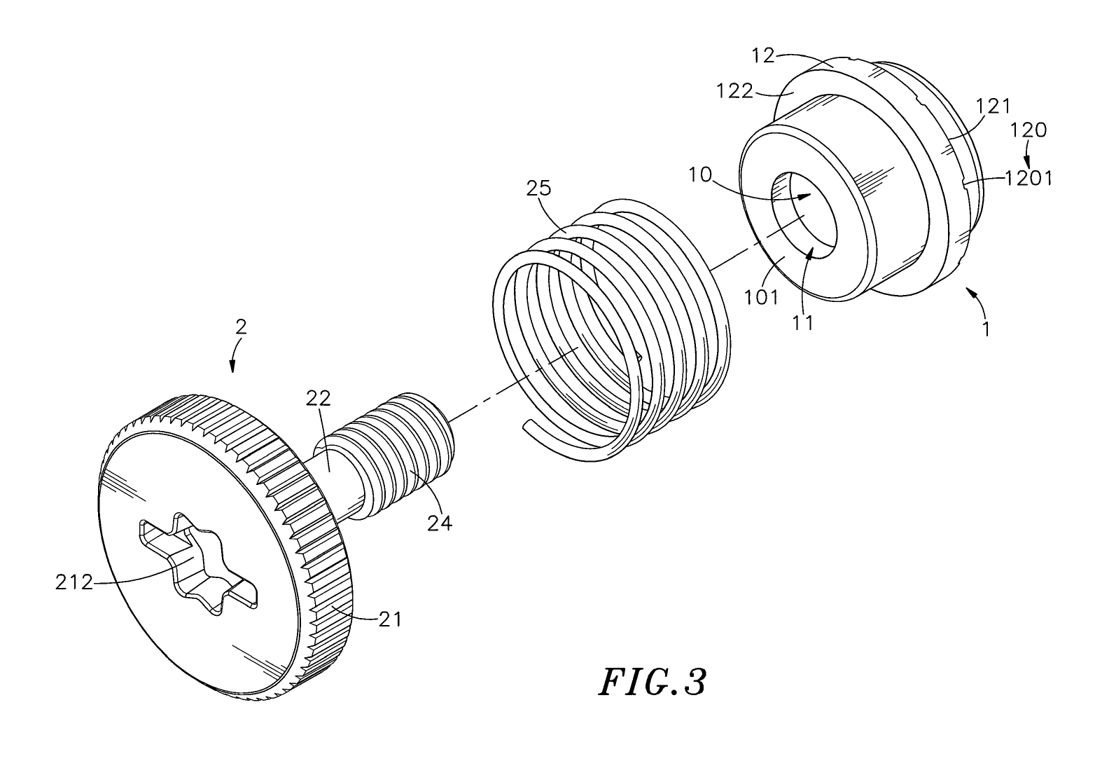

FIG. 4 is a sectional exploded view of the floating fastener in accordance with the first embodiment of the present invention.

FIG. 5 is a schematic sectional view illustrating an assembly operation of the first embodiment of the present invention (I).

FIG. 6 is a schematic sectional view illustrating an assembly operation of the first embodiment of the present invention (II).

FIG. 7 is a schematic sectional view illustrating an installation operation of the first embodiment of the present invention (I).

FIG. 8 is a schematic sectional view illustrating an installation operation of the first embodiment of the present invention (II).

FIG. 9 is a schematic sectional view of the first embodiment of the present invention, illustrating an operation to disengage the shoulder of the locking member from the transverse wall of the mounting socket after bonding of the mounting socket to a first plate member.

FIG. 10 is a schematic sectional applied view of the first embodiment of the present invention, illustrating an operation to lock the first plate member to a second plate member.

FIG. 11 is an exploded view of a floating fastener in accordance with a second embodiment of the present invention.

FIG. 12 is a sectional exploded view of the floating fastener in accordance with the second embodiment of the present invention.

FIG. 13 is a schematic sectional view of the second embodiment of the present invention, illustrating an operation to disengage the shoulder of the locking member from the transverse wall of the mounting socket after bonding of the mounting socket to a first plate member.

FIG. 14 is a sectional view of a floating captive screw according to the prior art.

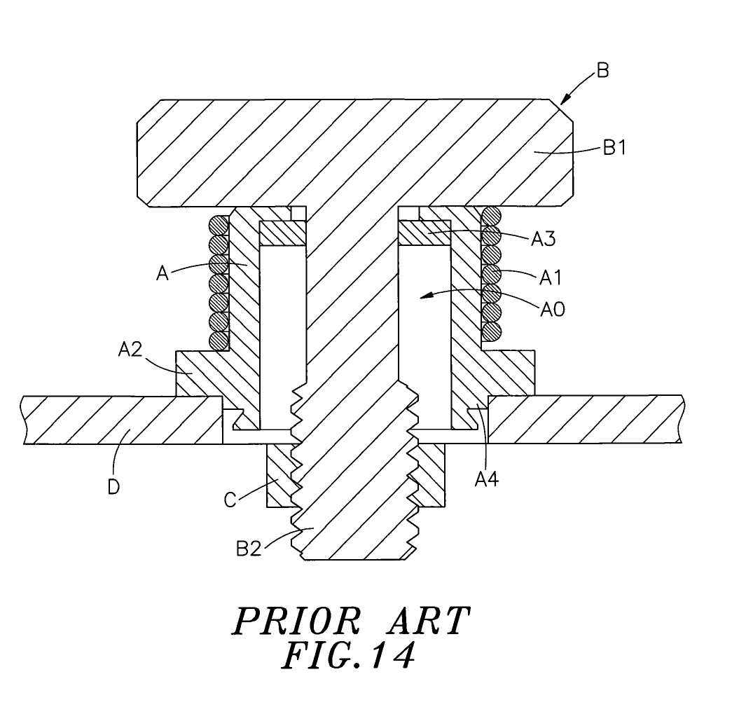

### DETAILED DESCRIPTION OF THE PREFERRED EMBODIMENT

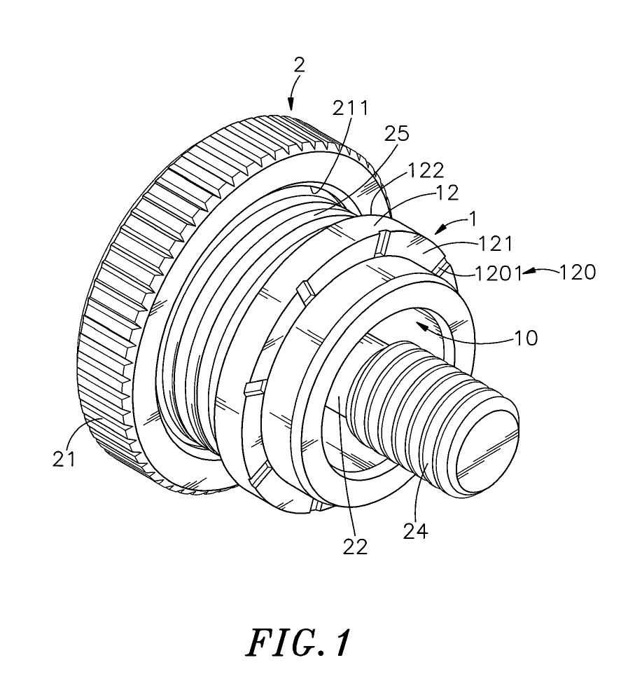

Referring to FIGS. 1˜4, a floating fastener in accordance with a first embodiment of the present invention is shown comprising a mounting socket 1, a locking member 2 and a spring member 25.

The mounting socket 1 has an open chamber 10 defined therein, a center hole 11 cut through one transverse wall 101 thereof and disposed in communication with the open chamber 10, a mounting ring 12 extending around the periphery thereof, and a plurality of locating portions 120 located on the bottom side of the mounting ring 12. The mounting socket 1 has a bonding surface 121 located on the bottom side of the mounting ring 12, and a bearing surface 122 located on the top side of the mounting ring 12. The locating portions 120 are located on the bonding surface 121. The diameter of the center hole 11 is smaller than the open chamber 10.

The locking member 2 has a head 21, a tool-driving device 212 located on the top wall of the head 21, a fastening end piece 24, a plain stem 22 connected between the head 21 and the fastening end piece 24, a shoulder 23 connected between the head 21 and the plain stem 22, an annular recess 211 located on the bottom wall of the head 21 around the shoulder 23, and a plurality of engagement portions 230 located on and equiangularly spaced around the shoulder 23. The outer diameter of the plain stem 22 is approximately equal to the diameter of the center hole 11. Further, the outer diameter of the fastening end piece 24 is greater than the outer diameter of the plain stem 22 and the diameter of the center hole 11.

The spring member 25 is sleeved onto the plain stem 22 of the locking member 2 and the mounting socket 1 and stopped between the head 21 of the locking member 2 and the mounting ring 12 of the mounting socket 1.

When assembling the component parts of the floating fastener, insert the fastening end piece 24 and plain stem 22 of the locking member 2 into the center hole 11 and open chamber 10 of the mounting socket 1 to let one end of the spring member 25 be stopped against the bearing surface 122 of the mounting ring 12 of the mounting socket 1 and the other end of the spring member 25 be positioned in the annular recess 211 of the head 21 of the locking member 2, and then impart a pressure to the head 21 of the locking member 2 toward the mounting socket 1 to force the engagement portions 230 of the locking member 2 into engagement with the periphery of the center hole 11 of the mounting socket 1. At this time, the fastening end piece 24 of the locking member 2 is kept suspending outside the open chamber 10 of the mounting socket 1. As the transverse wall 101 of the mounting socket 1 is flexible and elastically deformable, the fastening end piece 24 of the locking member 2 can be inserted through the center hole 11 of the mounting socket 1 by force. When inserting the fastening end piece 24 of the locking member 2 into the center hole 11, the transverse wall 101 will be forced to expand the center hole 11 for letting the fastening end piece 24 pass. After insertion of the fastening end piece 24 through the center hole 11, the transverse wall 101 immediately returns to its former shape subject to its flexible and elastically deformable material property.

As the floating fastener simply consists of the mounting socket 1, the locking member 2 and the spring member 25, it is easy and inexpensive to manufacture and easy to install, saving much installation labor and time.

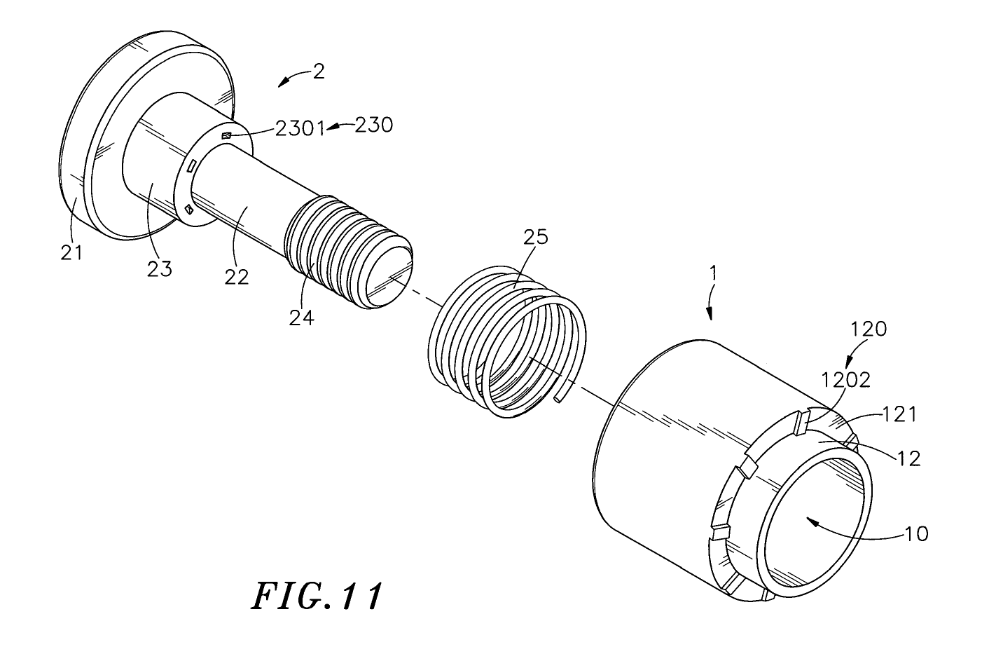

As stated above, the mounting ring 12 is located on the periphery of the mounting socket 1, having a bonding surface 121 located on its bottom side, i.e., the side close to the center hole 11, and a bearing surface 122 located on its top side, i.e., the side remote from the center hole 11. Further, the locating portions 120 that are located on the bonding surface 121 of the mounting ring 12 can be radial grooves 1201. Alternatively, as shown in FIG. 11, the locating portions 120 can be raised portions 1202 protruded from the bonding surface 121 of the mounting ring 12. Alternatively, the locating portions 120 can be a regularly corrugated design or irregularly corrugated design located on bonding surface 121 of the mounting ring 12. Subject to the design of the locating portions 120, solder paste accommodation gaps are defined in the bonding surface 121 of the mounting ring 12. Further, the transverse wall 101 of the mounting socket 1 is a flexible wall, having a relatively thicker center area 102 extending around the center hole 11 and highly elastically deformable.

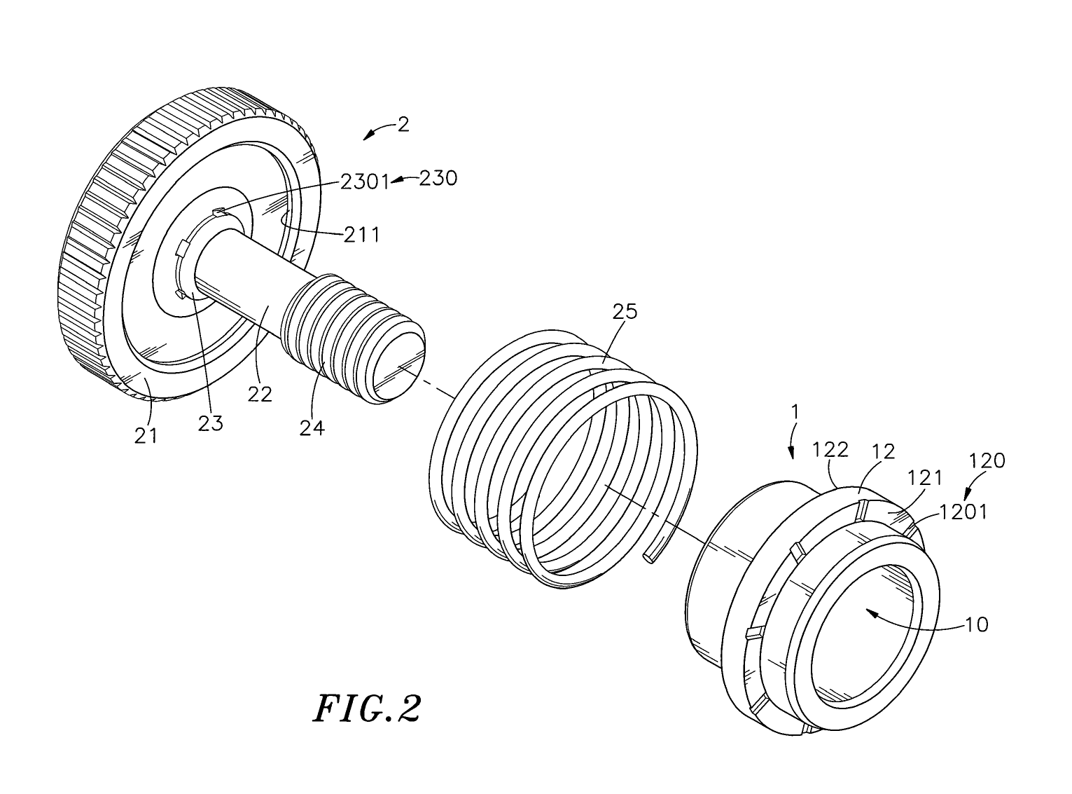

Further, the fastening end piece 24 of the locking member 2 can be a threaded shank or lock pin for locking. According ₜo ₜhe present preferred embodiment, the floating fastener is a floating captive screw, and the locking member 2 is a lock screw, i.e., the fastening end piece 24 of the locking member 2 is a threaded shank. Further, the engagement portions 230 that are located on and equiangularly spaced around the shoulder 23 in the annular recess 211 of the head 21 of the locking member 2 can be grooves 2301 (see FIG. 2). Alternatively, the engagement portions 230 can be ribs (not shown) raised from and equiangularly spaced around the periphery of the shoulder 23. Further, the tool-driving device 212 on the top wall of the head 21 of the locking member 2 can be a Phillips groove, keystone groove, asterisk groove, hex groove, or any other design of tool groove for driving by a Phillips-tip screwdriver, keystone-tip screwdriver, asterisk-tip screwdriver, hex-tip screwdriver, or any other matching design tool. Alternatively, tool-driving device 212 can be a Phillips rib, keystone rib, asterisk rib, hex rib, or any other design of rib raised from the top wall of the head 21 of the locking member 2 for driving by a matching manual or power wrench tool.

Further, the shoulder 23 that is connected between the head 21 and the plain stem 22 can be tapered or beveled, and the engagement portions 230 can be located on the tapered or beveled periphery of the shoulder 23. By means of using a tool to rotate the head 21 of the locking member 2, the engagement portions 230 and the shoulder 23 can be forced into the center hole 11 and engaged with the transverse wall 101 of the mounting socket 1, or moved away from the transverse wall 101 of the mounting socket 1.

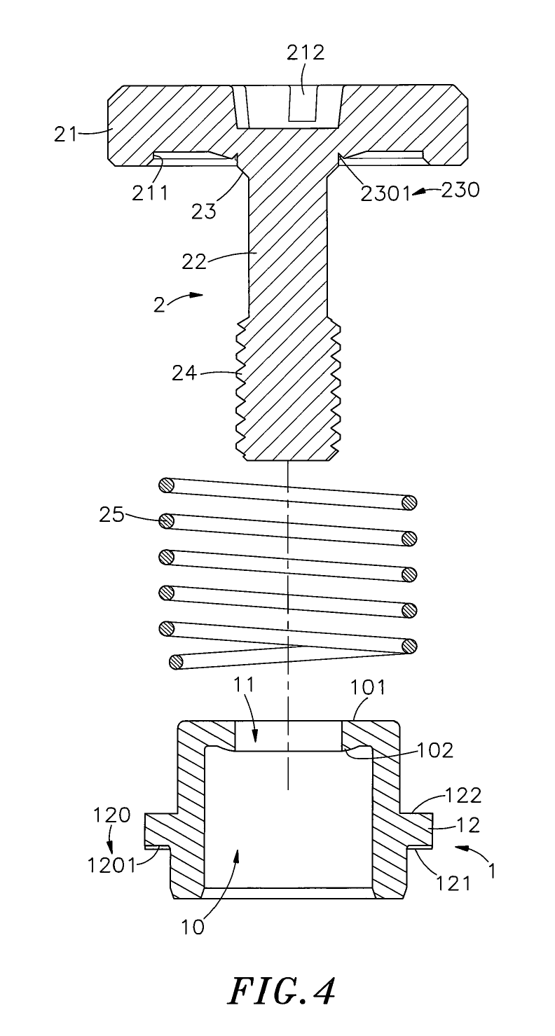

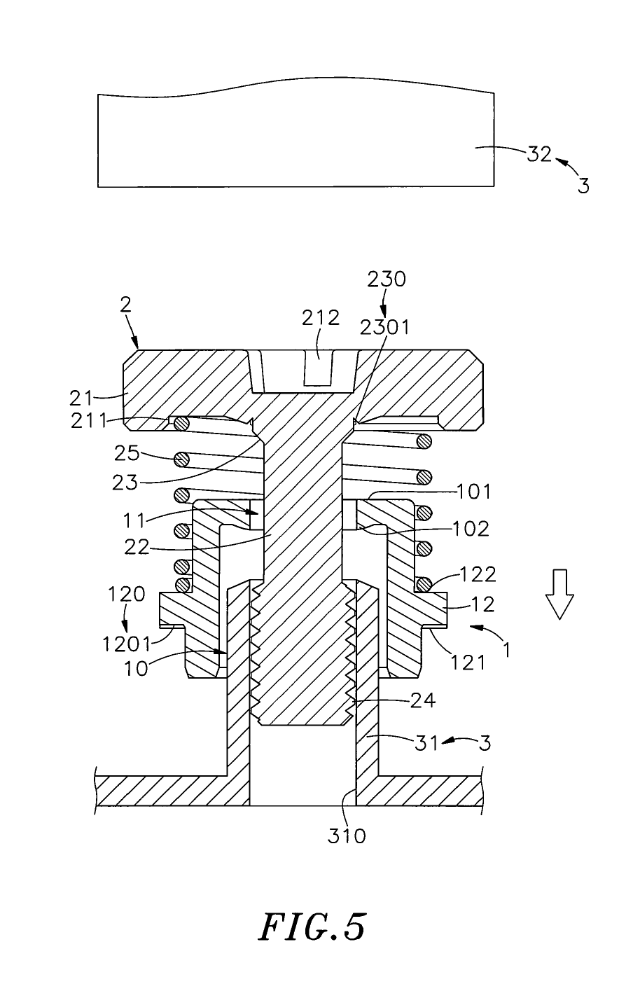

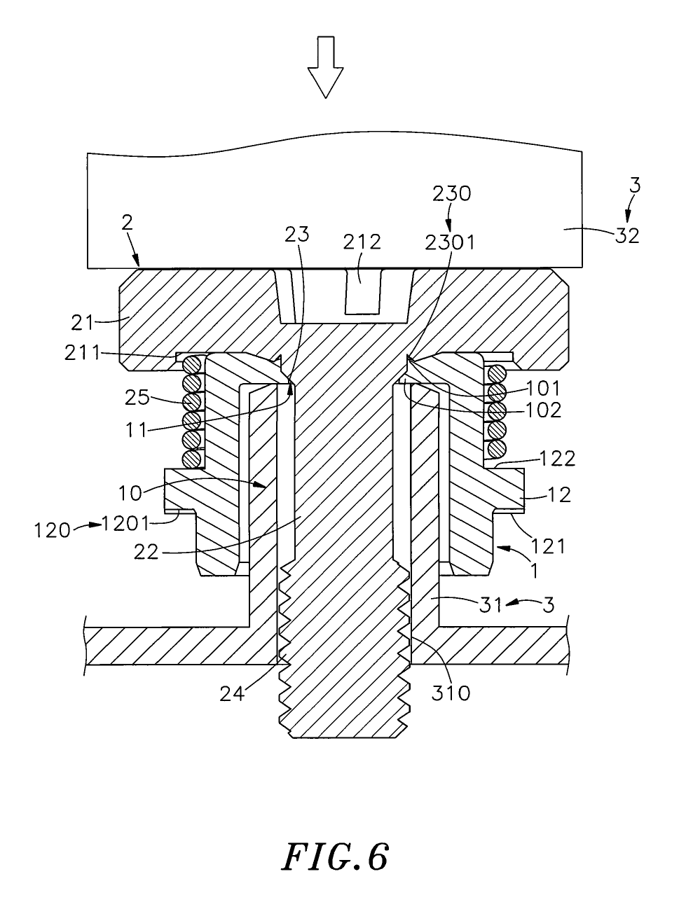

Referring to FIGS. 2, 4, 5 and 6, after insertion of the fastening end piece 24 and plain stem 22 of the locking member 2 into the center hole 11 and open chamber 10 of the mounting socket 1 to let one end of the spring member 25 be stopped against the bearing surface 122 of the mounting ring 12 of the mounting socket 1 and the other end of the spring member 25 be positioned in the annular recess 211 of the head 21 of the locking member 2, insert a bottom die 31 of a mold 3 into the open chamber 10 of the mounting socket 1 to let the fastening end piece 24 and plain stem 22 of the locking member 2 be received in a mold hole 310 in the bottom die 31, and then apply a downward pressure to a top die 32 of the mold 3 against the head 21 of the locking member 2 toward the bottom die 31 to move the head 21 to the transverse wall 101 of the mounting socket 1, and then keep applying the downward pressure to the top die 32 of the mold 3 against the head 21 of the locking member 2 to have the transverse wall 101 of the mounting socket 1 is a flexible wall, having the relatively thicker center area 102 of the transverse wall 101 of the mounting socket 1 be elastically deformably squeezed against the bottom die 31 and the engagement portions 230 of the shoulder 23 of the locking member 2 be forced into engagement with the peripheral wall of the center hole 11. After removal of the bottom die 31 and top die 32 of the mold 3 from the floating fastener, the transverse wall 101 of the mounting socket 1 is kept secured to the shoulder 23 of the locking member 2 subject to its elastically deformable material property, and the spring member 25 is kept compressed and stopped between the annular recess 211 on the bottom wall of the head 21 around the shoulder 23 and the bearing surface 122 located on the top side of the mounting ring 12 of the mounting socket 1.

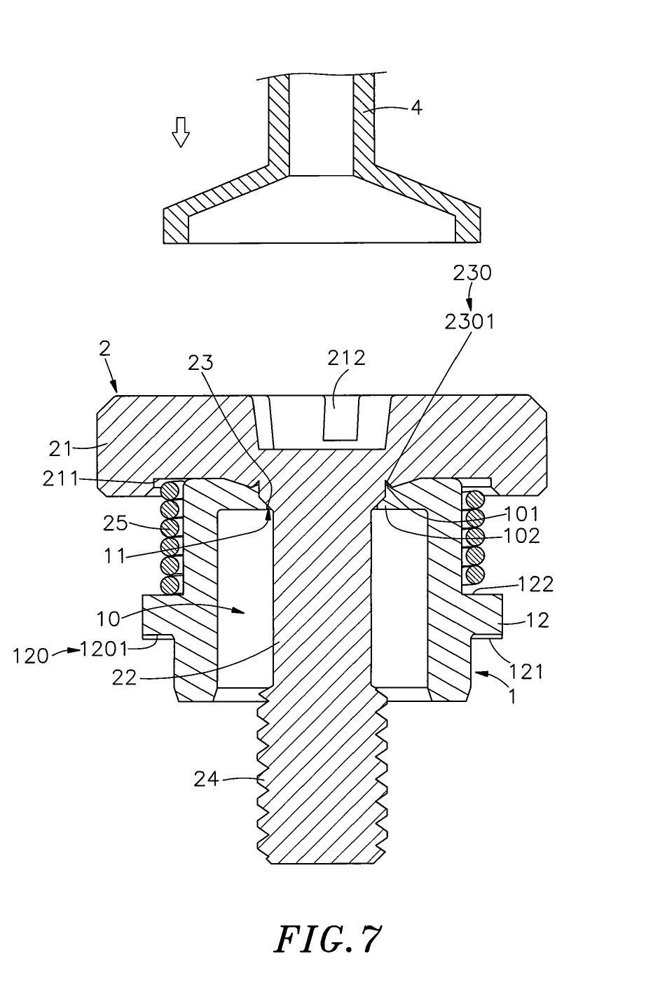

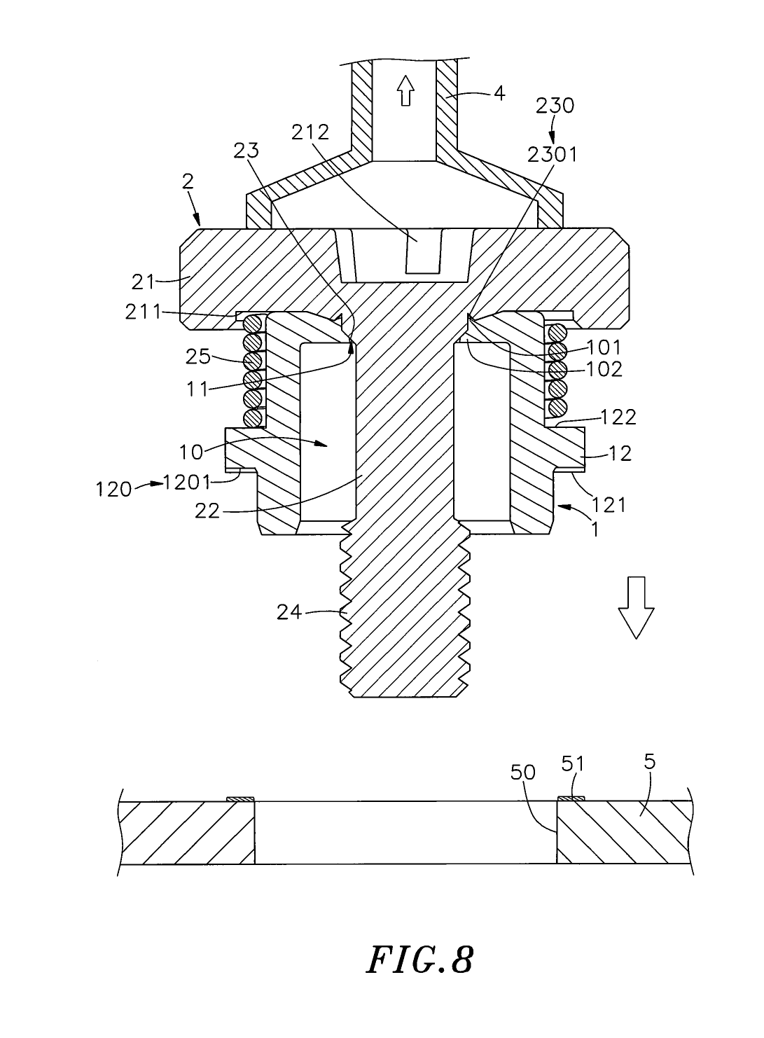

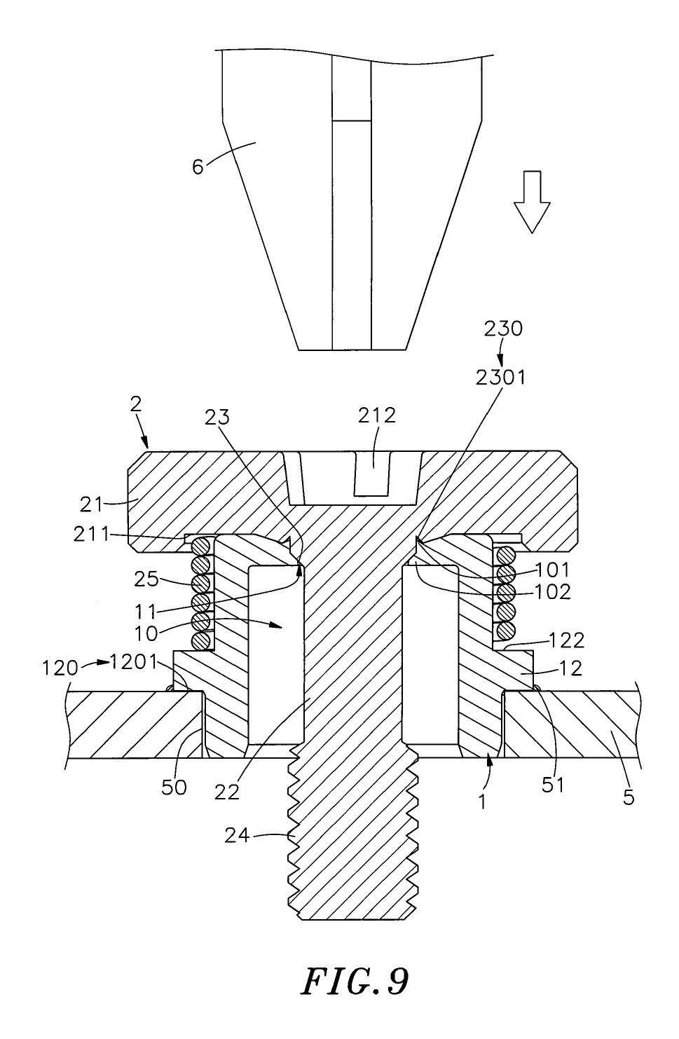

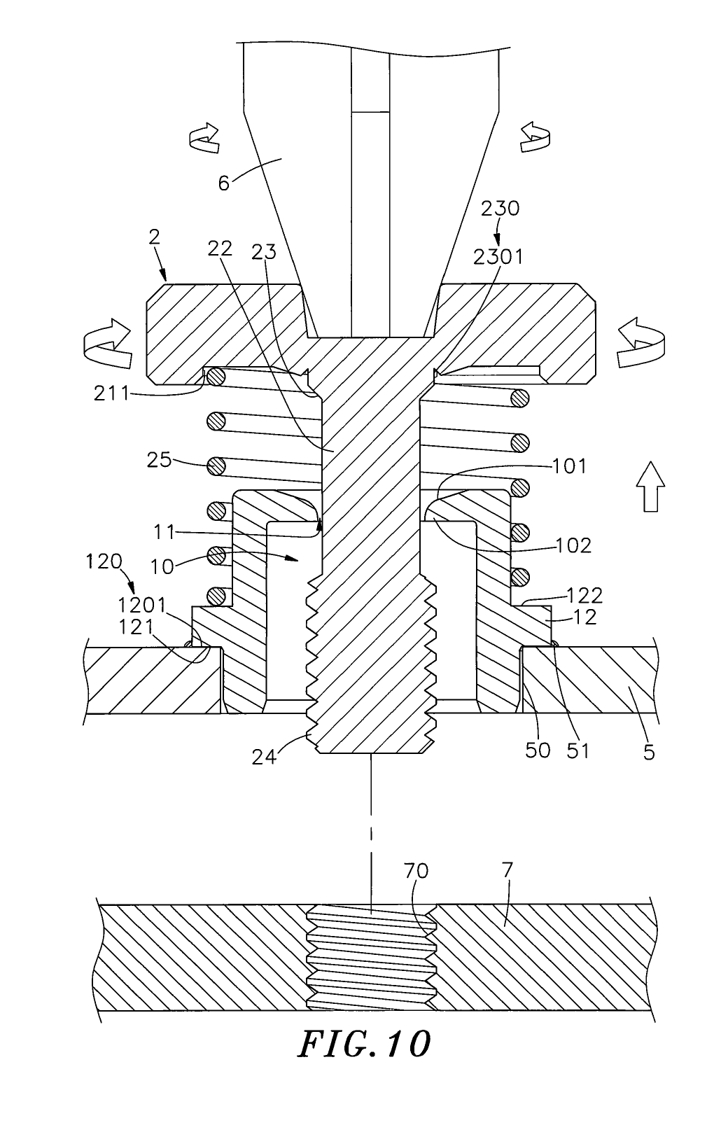

Referring to FIGS. 7, 8, 9 and 10, during installation of the floating fastener (floating captive screw), a suction pump (suction lifter) is attached to the head 21 of the locking member 2 and operated to carry the floating fastener to a first plate member 5 and then to insert the fastening end piece 24 of the locking member 2 and the mounting socket 1 into a mounting through hole 50 on the first plate member 5, enabling the bonding surface 121 of the mounting ring 12 to be stopped against the top surface of the first plate member 5 around the mounting through hole 50. Thereafter, fill a solder material 51 (solder paste or solder balls) in between the bonding surface 121 of the mounting ring 12 and the top surface of the first plate member 5 around the mounting through hole 50, and then apply a reflow soldering technique to bond the mounting socket 1 to the first plate member 5. Subject to the design of the locating portions 120, solder paste accommodation gaps are defined in between the bonding surface 121 of the mounting ring 12 and the top surface of the first plate member 5 for accommodating the applied solder material, assuring positive bonding between the mounting socket 1 and the first plate member 5 after the reflow soldering process.

After bonding between the mounting socket 1 and the first plate member 5, a manual or power tool 6 is attached to the tool-driving device 212 on the top wall of the head 21 of the locking member 2 and operated to rotate the locking member 2 relative to the mounting socket 1 and the first plate member 5, disengaging the shoulder 23 of the locking member 2 from the transverse wall 101 of the mounting socket 1. As the mounting socket 1 is fixedly bonded to the first plate member 5, rotating the locking member 2 does not cause rotation of the mounting socket 1, and therefore the shoulder 23 of the locking member 2 can be quickly disengaged from the transverse wall 101 of the mounting socket 1. After disengagement of the shoulder 23 of the locking member 2 from the transverse wall 101 of the mounting socket 1, the spring member 25 is released from the constraint to return to its former shape and to push the head 21 of the locking member 2 outwardly away from the mounting socket 1. At this time, the fastening end piece 24 of the locking member 2 will be stopped at the relatively thicker center area 102 of the transverse wall 101 of the mounting socket 1, allowing floating of the locking member 2 relative to the mounting socket 1 and preventing falling of the locking member 2 and the spring member 25 from the mounting socket 1.

When fastening the first plate member 5 to a second plate member 7, attach the first plate member 5 to the second plate member 7 to keep the mounting through hole 50 of the first metal plate member 5 in axial alignment with a corresponding mounting hole 70 on the second metal plate member 7, and then attach a manual or power tool 6 to the tool-driving device 212 on the top wall of the head 21 of the locking member 2 and operate the manual or power tool 6 to drive the fastening end piece 24 of the locking member 2 into the mounting hole 70 of the second metal plate member 7, thereby locking the first metal plate member 5 and the second metal plate member 7 together. The mounting hole 70 of the second metal plate member 7 matches the fastening end piece 24 of the locking member 2. If the fastening end piece 24 of the locking member 2 is a threaded shank, the mounting hole 70 of the second metal plate member 7 shall be a screw hole; if the fastening end piece 24 of the locking member 2 is a lock pin, the mounting hole 70 of the second metal plate member 7 shall be a pinhole. Thus, the installation operation is simple, requiring less installation labor and time.

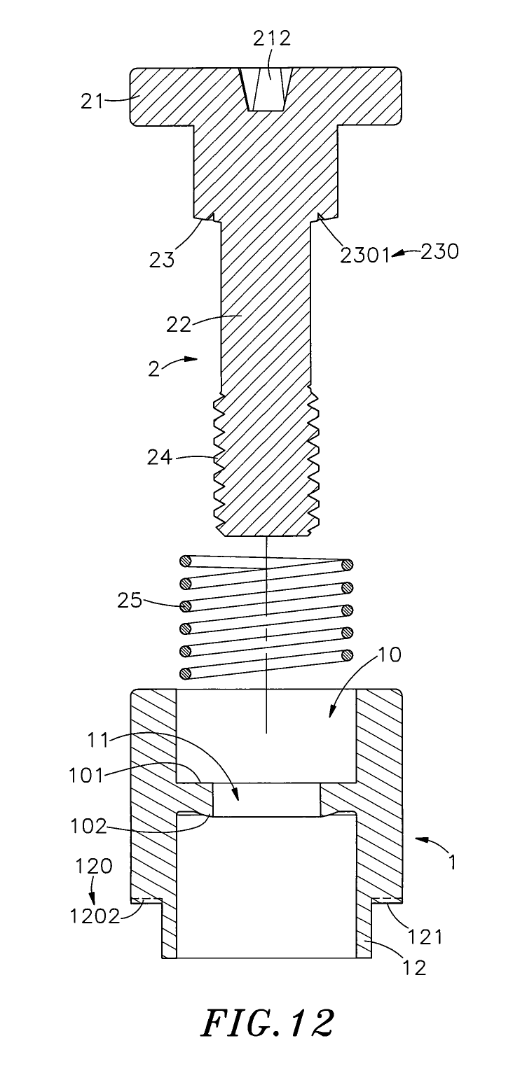

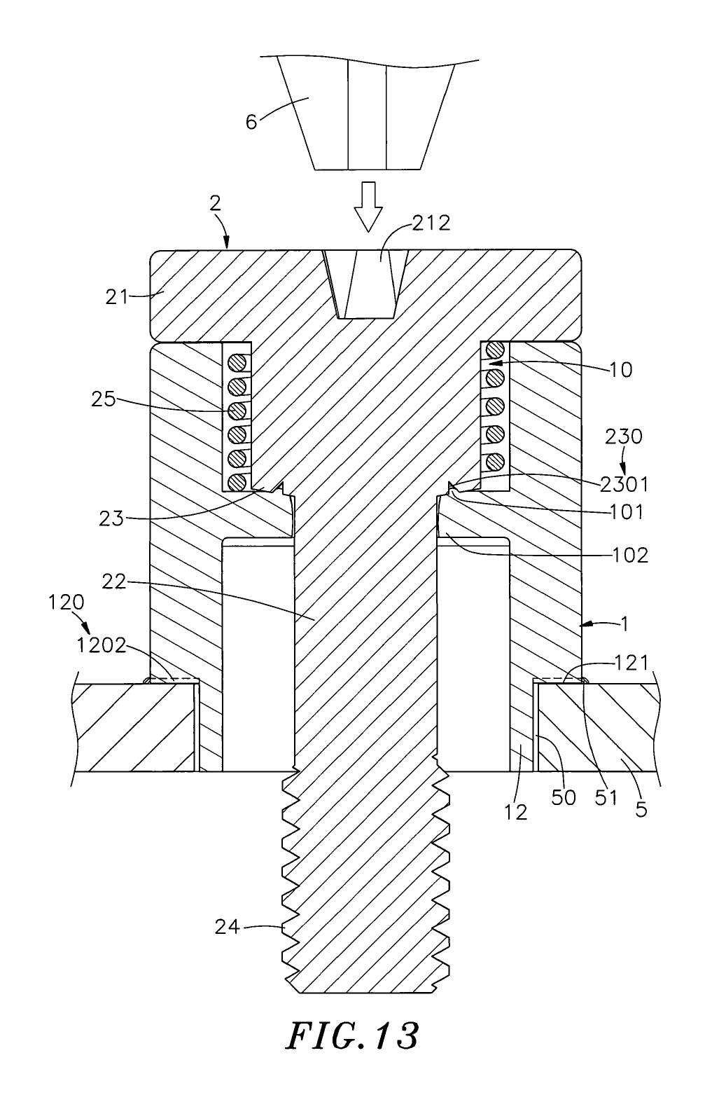

FIGS. 11, 12 and 13 illustrate a floating fastener in accordance with a second embodiment of the present invention. This second embodiment is substantially similar to the aforesaid first embodiment with the exception that the transverse wall 101 is located on the middle inside of the open chamber 10 of the mounting socket 1; the mounting ring 12 is an extension ring axially extended from the bottom edge of the mounting socket 1 and having a relatively smaller outer diameter relative to the mounting socket 1; the bonding surface 121 is located on the bottom edge of the mounting socket 1 around the mounting ring 12, and the locating portions 120 are located on the bonding surface 121 at the bottom edge of the mounting socket 1 around the mounting ring 12; the mounting socket 1 eliminates the aforesaid bearing surface 122; the engagement portions 230 are located on the beveled bottom edge of the shoulder 23 and equiangularly spaced around the plain stem 22.

When assembling the floating fastener, sleeve the spring member 25 onto the fastening end piece 24, plain stem 22 and shoulder 23 of the locking member 2, and then insert the fastening end piece 24 and plain stem 22 of the locking member 2 through the center hole 11 of the transverse wall 101 by force to let the spring member 25 be received in the open chamber 10 inside the mounting socket 1 and stopped between the transverse wall 101 of the mounting socket 1 and the head 21 of the locking member 2, and then apply a downward pressure to the head 21 of the locking member 2 relative to the mounting socket 1 to force the engagement portions 230 against the transverse wall 101, causing the relatively thicker center area 102 of the transverse wall 101 of the mounting socket 1 to be elastically deformably squeezed and forced into engagement with the grooves 2301 of the engagement portions 230 of the shoulder 23 of the locking member 2. At this time, the spring member 25 is compressed and kept inside the open chamber 10 of the mounting socket 1 between the head 21 of the locking member 2 and the transverse wall 101 of the mounting socket 1.

Thereafter, the assembled floating fastener can then be installed in a first plate member 5 by: inserting the mounting ring 12 of the mounting socket 1 into a mounting through hole 50 on the first plate member 5 to have the bonding surface 121 of the mounting socket 1 be stopped at the top surface of the first plate member 5 around the mounting through hole 50, and then filling a solder material 51 (solder paste or solder balls) in between the bonding surface 121 of the mounting ring 12 and the top surface of the first plate member 5 around the mounting through hole 50, and then applying a reflow soldering technique to bond the mounting socket 1 to the first plate member 5. After bonding between the mounting socket 1 and the first plate member 5, a manual or power tool 6 is attached to the tool-driving device 212 on the top wall of the head 21 of the locking member 2 and operated to rotate the locking member 2 relative to the mounting socket 1 and the first plate member 5, disengaging the engagement portions 230 of the shoulder 23 of the locking member 2 from the transverse wall 101 of the mounting socket 1. After disengagement of the engagement portions 230 of the shoulder 23 of the locking member 2 from the transverse wall 101 of the mounting socket 1, the spring member 25 is released from the constraint to return to its former shape and to push the head 21 of the locking member 2 outwardly away from the mounting socket 1. At this time, the fastening end piece 24 of the locking member 2 is stopped below the transverse wall 101 inside the mounting socket 1, and therefore the locking member 2 is floatably secured to the mounting socket 1 at the first plate member 5.

The above described embodiments are simply examples of the invention but not intended for us as limitations of the invention. In general, the invention provides a floating fastener, which comprises a mounting socket 1, which defines therein an open chamber 10 and comprises a center hole 11 on a flexible and elastically deformable transverse wall 101 thereof, and a mounting ring 12 and a bonding surface 121 for bonding to a plate member 5, a locking member 2, which comprises a fastening end piece 24 that is forced through the center hole 11 of the mounting socket 1 and stoppable at one side of the flexible and elastically deformable transverse wall 101, a head 21 suspending outside the mounting socket 1, a plain stem 22 extending through the center hole 11 and connected between the head 21 and the fastening end piece 24 and a shoulder 23 connected between the head 21 and the plain stem 22 and engageable with the relatively thicker center area 102 of the transverse wall 101 around the center hole 11 to lock the locking member 2 to the mounting socket 1 temporarily, and a spring member 25 sleeved onto the locking member 2 and stopped between the head 21 of the locking member 2 and the mounting ring 12 or transverse wall 101 of the mounting socket 1. The mounting socket 1 further comprises a plurality of locating portions 120 on the bonding surface 121. By means of applying a pressure to squeeze the transverse wall 101 against the shoulder 23, the relatively thicker center area 102 of the transverse wall 101 around the center hole 11 is elastically deformed, causing engagement between the shoulder 23 and the relatively thicker center area 102. When the bonding surface 121 is attached to the top surface of the plate member 5 for bonding, solder paste accommodation gaps are defined in between the bonding surface 121 of the mounting socket 1 and the top surface of the plate member 5, subject to the design of the locating portions 120, for accommodating the applied solder material, assuring positive bonding between the mounting socket 1 and the plate member 5 after a reflow soldering process. After bonding between the mounting socket 1 and the plate member 5, a manual or power tool 6 can be operate to rotate the locking member 2 relative to the mounting socket 1 and the plate member 5, thereby disengaging the shoulder 23 from the relatively thicker center area 102 of the transverse wall 101, and thus the locking member 2 is kept floating in the mounting socket 1. Because the floating fastener simply consists of a limited number of component parts, it is easy and inexpensive to manufacture and easy to install, saving much installation labor and time.

In actual application, the floating fastener has the advantages as follows:
1. The floating fastener simply consists of three component parts, i.e., the mounting socket 1, the locking member 2 and the spring member 25. Therefore, the floating fastener is easy and inexpensive to manufacture and easy to install, saving much installation labor and time.
2. The mounting socket 1 has multiple locating portions 120 located on the bonding surface 121. When the bonding surface 121 is attached to the top surface of a plate member 5 for bonding, solder paste accommodation gaps are defined in between the bonding surface 121 of the mounting socket 1 and the top surface of the plate member 5, subject to the design of the locating portions 120, for accommodating the applied solder material, assuring positive bonding between the mounting socket 1 and the plate member 5 after a reflow soldering process.

It is to be understood that the above-described embodiments of the invention are merely possible examples of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A floating fastener adapted for mounting in a first plate member for detachably fastening said first plate member to a second plate member, comprising:
a mounting socket, said mounting socket comprising an open chamber, a transverse wall, a center hole cut through said transverse wall and disposed in communication with said open chamber, a mounting ring, a bonding surface for bonding to said first plate member and a plurality of locating portions located on said bonding surface for allowing formation of solder paste accommodation gaps in between said bonding surface and said first plate member for accommodating a solder material when said bonding surface is attached to said first plate member for bonding, said transverse wall having a relatively thicker center area extending around said center hole and elastically deformable;
a locking member adapted for fastening to said second plate member after bonding said bonding surface of said mounting socket to said first plate member, said locking member comprising a head suspending outside said mounting socket, a fastening end piece fastenable to said second plate member, a plain stem connected between said head and said fastening end piece and inserted through said center hole of said mounting socket, a shoulder connected between said head, and a plurality of engagement portions located on said shoulder and engageable with the relatively thicker center area of said transverse wall; and
a spring member sleeved onto the fastening end piece, plain stem and shoulder of said locking member and stopped between the head of said locking member and a part of said mounting socket.

2. The floating fastener as claimed in claim 1, wherein said open chamber extends axially through two distal ends of said mounting socket; said transverse wall of said mounting socket is located on one end of said mounting socket; said mounting ring extends around the periphery of said mounting socket, having a bearing wall located on a top side thereof and a bottom wall located on a bottom side thereof and forming said bonding surface.

3. The floating fastener as claimed in claim 1, wherein said transverse wall of said mounting socket is disposed inside said open chamber; said mounting ring extends axially from one end of said mounting socket, having an outer diameter smaller than said mounting socket; said bonding surface is located on one end of said mounting socket and extending around said mounting ring.

4. The floating fastener as claimed in claim 1, wherein said transverse wall of said mounting socket is located on one end of said mounting socket; said mounting ring extends around the periphery of said mounting socket, having a top side disposed close to said transverse wall and a bottom side disposed remote from said transverse wall and defining said bonding surface; said locating portions are located on the bottom side of said mounting ring.

5. The floating fastener as claimed in claim 4, wherein said locating portions are locating grooves.

6. The floating fastener as claimed in claim 4, wherein said locating portions are raised portions protruded from said bonding surface.

7. The floating fastener as claimed in claim 1, wherein said fastening end piece of said locking member is a threaded shank.

8. The floating fastener as claimed in claim 1, wherein said fastening end piece of said locking member is a lock pin.

9. The floating fastener as claimed in claim 1, wherein said locking member further comprises a plurality of engagement portions located on and equiangularly spaced around said shoulder.

10. The floating fastener as claimed in claim 1, wherein said locking member further comprises a plurality of engagement portions located on a beveled bottom edge of said shoulder and equiangularly spaced around said plain stem.
